(19) United States
(12) Patent Application Publication
(10) Pub. No.: US 2009/0281680 A1
(43) Pub. Date: Nov. 12, 2009

(54) Method and apparatus for simultaneously playing video frame and trip message and controller thereof

(75) Inventors: Steven Shen, Yunlin County (TW); Chia-Chung Chen, Taichung County (TW); Fu-Ming Jheng, Taipei County (TW)

Correspondence Address: J C PATENTS, 4 VENTURE, SUITE 250, IRVINE, CA, 92618, US

(73) Assignee: FlexMedia Electronics Corp., Hsinchu County (TW)

(21) Appl. No.: 12/214,396

(22) Filed: Jun. 17, 2008

(30) Foreign Application Priority Data
May 6, 2008 (TW) 97116635

(51) Int. Cl. G01C 21/00; G06F 3/14

(52) U.S. Cl. 701/1; 701/200

(57) ABSTRACT

The present invention provides a method for simultaneously playing video frames and trip message, and the method includes the following steps: (a) receiving a trip video frame data; (b) decoding the trip video frame data to obtain a plurality of video frames and a plurality of trip message, wherein each of the trip message corresponds to one of the video frames; (c) simultaneously displaying at least one video frame and its corresponding trip message. When the user uses the method for playing the trip video frame data, the user can simultaneously see the video frame and its corresponding trip message, so as to achieve a good performance of monitoring.

### CROSS-REFERENCE TO RELATED APPLICATION

This application claims the priority benefit of Taiwan application serial no. 97116635, filed on May 6, 2008. The entirety of the above-mentioned patent application is hereby incorporated by reference herein and made a part of this specification.

### BACKGROUND OF THE INVENTION

1. Field of the Invention

The present invention relates to a method and an apparatus for displaying video frames and a controller thereof. More particularly, the present invention relates to a method and an apparatus for simultaneously playing video frames and trip message, and a controller thereof.

2. Description of Related Art

With development of global positioning system (GPS), some vehicles are equipped with navigation equipments, so that drivers know such information as traffic status, a present location and how to reach a destination. Moreover, with development of video-recording equipments, people arbitrarily record immediate videos to generate video streaming.

FIG. 1 is a schematic diagram illustrating a constitution of a conventional video streaming. Referring to FIG. 1, the video streaming is generally composed of a plurality of video frames 10, 11, 12, . . . , 1n, and the video frames 10, 11, 12, . . . , 1n respectively include headers 100, 110, 120, . . . , 1n0 or a plurality of redundancy bits. When the conventional video streaming is played, the headers 100, 110, 120, . . . , 1n0 or the plurality of redundancy bits of the video frames 10, 11, 12, . . . , 1n are decoded, so as to correctly play the video frames 10, 11, 12, . . . , 1n. In other words, related information such as quantified table and time map, etc. of the video frames 10, 11, 12, . . . , 1n are recorded in the headers 100, 110, 120, . . . , 1n0 or the redundancy bits of the video frames 10, 11, 12, . . . , 1n.

Besides the aforementioned conventional video streaming, another type of conventional video streaming includes a plurality of video frames and a plurality of video information. Wherein, each of the video information records a file name, a file format, a video resolution and a bit rate, etc. of the corresponding video frame.

Next, FIG. 2 is a schematic diagram of geographic trip message provided by a conventional navigation system and a vehicle computer. Referring to FIG. 2, when the vehicle runs or sails, the geographic trip message provided by the navigation system and the vehicle computer generally includes speed, engine rotating speed (not shown in FIG. 2), fuel quantity (not shown in FIG. 2), engine temperature (not shown in FIG. 2), longitude and latitude, altitude and time, etc. Wherein, the speed includes a speed rate and a forward direction (for example, represented by an angle formed by the forward direction and the north direction). Moreover, the speed, the engine rotating speed, the fuel quantity and the engine temperature can be provided by the vehicle computer, and the longitude and latitude, the altitude and the time can be provided by the navigation system.

Though utilization of the video-recording equipment and the navigation system greatly facilitate people, they are separately sold in the market. Though the driver can be guided by the navigation system and the vehicle computer, and all images along a trip path or a driving path can be recorded to generate the video streaming, the trip message (such as longitude and latitude, altitude, road name, time, speed, forward direction, engine rotating speed, fuel quantity, and the engine temperature, etc) provided by the navigation system and the vehicle computer is not altogether recorded in the video streaming. Therefore, when the recorded video streaming is required to be replayed after a car accident or due to other reasons, it is inconvenient for a user to see the video frames recorded at a specific path or at a specific longitude and latitude due to lack of trip message.

### SUMMARY OF THE INVENTION

The present invention is directed to a method and an apparatus for simultaneously playing video frames and trip message, which plays a trip video frame data having a plurality of trip message, and simultaneously plays video frames and the corresponding trip message.

The present invention provides a method for simultaneously playing video frames and trip message, the method includes the following steps: (a) receiving a trip video frame data; (b) decoding the trip video frame data to obtain a plurality of video frames and a plurality of trip message, wherein each of the trip message corresponds to one of the video frames; (c) simultaneously displaying at least one video frame and a trip message corresponding to the video frame.

According to an embodiment of the present invention, the method further includes: (d) displaying at least one trip announcement according to the plurality of trip message; (e) receiving a designated tag message; (f) displaying the corresponding video frame and the trip message according to the designated tag message.

The present invention provides an apparatus for simultaneously playing video frames and trip message, the apparatus includes a trip video frame data decoder and a player. The trip video frame data decoder is used for receiving a trip video frame data and decoding the trip video frame data to obtain a plurality of video frames and a plurality of trip message, wherein each of the trip message corresponds to one of the video frames. The player is coupled to the trip video frame data decoder for simultaneously displaying at least a video frame and the corresponding trip message.

In an embodiment of the present invention, the player further displays at least one trip announcement according to the plurality of trip message, and is used for receiving a designated tag message, and displaying the corresponding video frame and the trip message according to the designated tag message.

The present invention provides a controller, adapted to simultaneously play video frames and trip message. The controller includes a micro processing unit and a memory unit. The memory unit is coupled to the micro processing unit. The micro processing unit is used for controlling other units connected to the controller. The memory stores a program code therein, and when the program code is executed, the micro processing unit controls the other units connected to the controller to perform the following steps: (a) receiving a trip video frame data; (b) decoding the trip video frame data to obtain a plurality of video frames and a plurality of trip message, wherein each of the trip message corresponds to one of the video frames; (c) simultaneously displaying at least one video frame and a trip message corresponding to the video frame.

In an embodiment of the present invention, the micro processing unit further controls the other units connected to the controller to perform the following steps: (d) displaying at least one trip announcement according to the plurality of trip message; (e) receiving a designated tag message; (f) displaying the corresponding video frame and the trip message according to the designated tag message.

The present invention provides a method and a controller for simultaneously playing video frames and trip message, and a controller thereof. When the trip video frame data is played based on the above method, apparatus and controller, the corresponding video frames can be searched according to the trip message (including geographic information and cruise status information), so that a user can conveniently search the video frames. Moreover, during the playing, the user can simultaneously see the video frames and the corresponding trip message, so that a better monitoring effect is achieved.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a constitution of a conventional video streaming.

FIG. 2 is a schematic diagram of trip message provided by a conventional navigation system and a vehicle computer.

FIG. 3A is a schematic diagram illustrating a data format of a trip video frame data having trip message according to an embodiment of the present invention.

FIG. 3B is a schematic diagram illustrating another data format of a trip video frame data having trip message according to an embodiment of the present invention.

FIG. 4 is a schematic diagram illustrating another data format of a trip video frame data having trip message according to an embodiment of the present invention.

FIG. 5 is a schematic diagram illustrating a map frame displayed based on a method for simultaneously playing video frames and trip message according to an embodiment of the present invention.

FIG. 6 is a schematic diagram of displaying frames displayed based on a method for simultaneously playing video frames and trip message according to an embodiment of the present invention.

FIG. 7 is a flowchart illustrating a method for simultaneously playing video frames and trip message according to an embodiment of the present invention.

FIG. 8 is a system block diagram illustrating an apparatus and a controller thereof for simultaneously playing video frames and trip message according to an embodiment of the present invention.

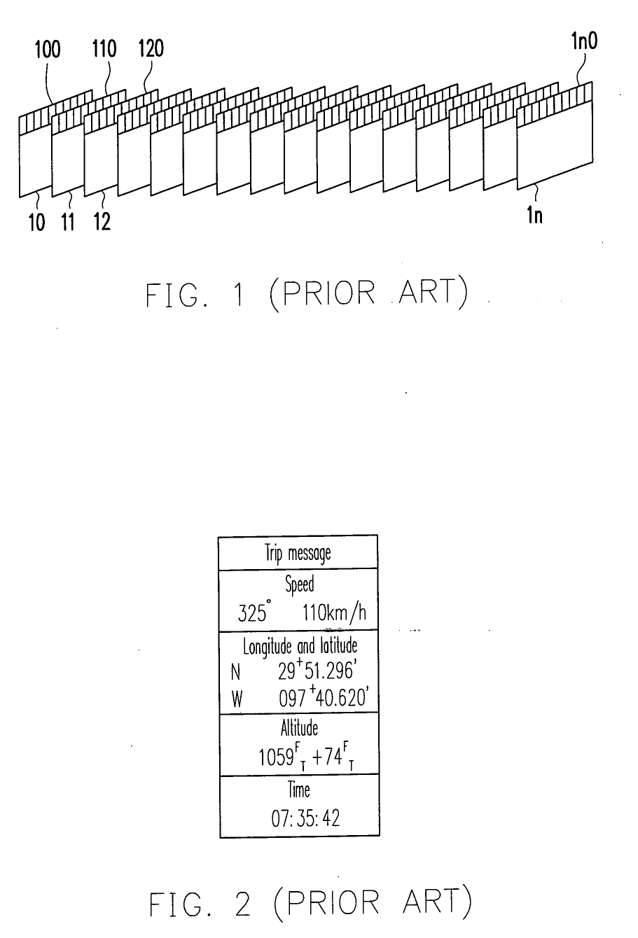

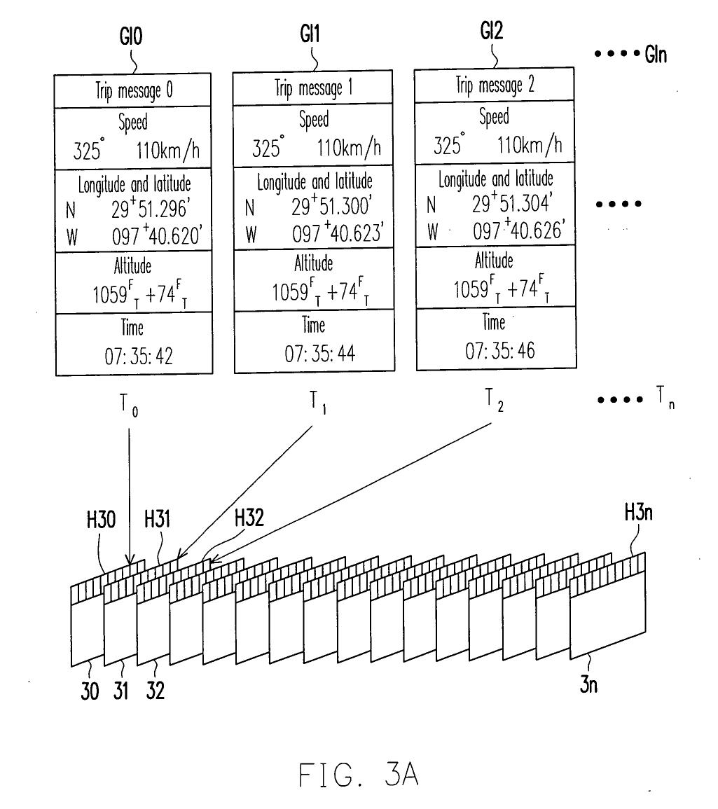

### DESCRIPTION OF EMBODIMENTS

Before a method for simultaneously playing video frames and trip message, and an apparatus thereof are described, data format of trip video frame data played based on the method and the apparatus is first described.

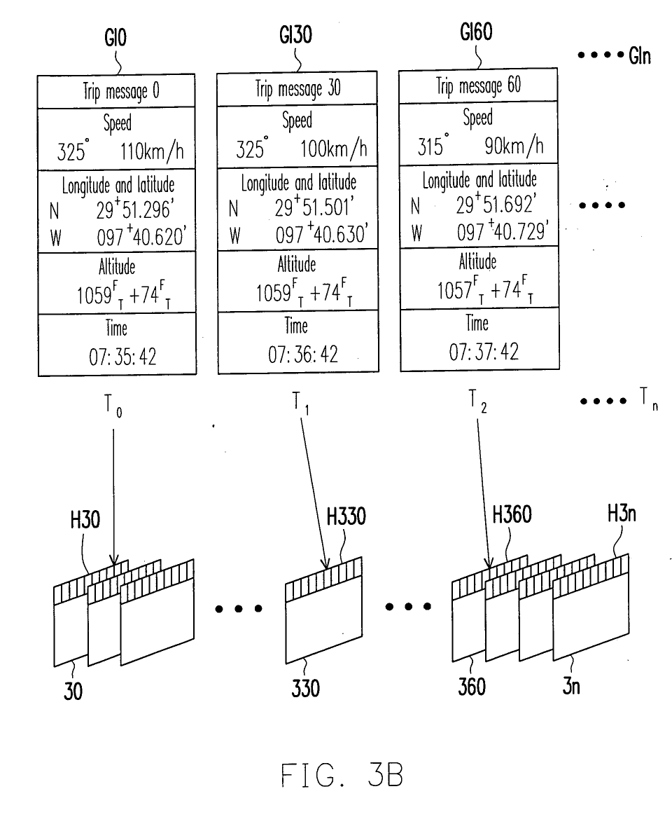

FIG. 3A is a schematic diagram illustrating a data format of a trip video frame data having trip message according to an embodiment of the present invention. Referring to FIG. 3A, the trip video frame data includes a video streaming. The video streaming includes a plurality of video frames 30, 31, 31, . . . , 3n, and the video frames 30˜3n respectively include headers H30, H31, H32, . . . , H3n or a plurality of redundancy bits.

In the data format of the trip video frame data, trip message GI0˜GIn are included within the headers H30, H31, H32, . . . , H3n or the redundancy bits of the video frames 30, 31, 32, . . . , 3n. Wherein, the trip message GI0˜GIn include speed, longitude and latitude, altitude and time, etc., and the speed includes a speed rate and a forward direction (for example, represented by an angle formed by a driving direction and the north direction). Moreover, the video frames 30˜3n respectively correspond to the trip message GI0˜GIn at time points T₀˜Tₙ.

The aforementioned trip message in the trip video frame data is not used for limiting the present invention. As described in the related art, the trip message include speed, engine rotating speed, fuel quantity, engine temperature, longitude and latitude, altitude and time, etc. Moreover, the speed, the engine rotating speed, the fuel quantity and the engine temperature can be provided by a vehicle computer, and the longitude and latitude, the altitude and the time can be provided by a GPS receiving module. In brief, the trip message include geographic information or cruise status information, for example, information that can be recorded by the vehicle computer of a vehicle, such as engine rotating speed, fuel quantity and engine temperature, etc. Certainly, the trip video frame data of the present embodiment can also be trip video frame data recorded on vehicles such as aircrafts or vessels, etc.

The data format of the trip video frame data is that the header or the redundancy bit of each of the video frames has the corresponding trip message. However, such data format is not used for limiting the present invention. Moreover, a similar data format is that the header or the redundancy bit of every 30 video frames has a corresponding trip message. In brief, the aforementioned data format is not used for limiting the present invention.

Generally, geographic information in the trip message is generated per second, and 30 video frames are generated per second. Therefore, a general situation is that 30 video frames correspond to one trip message. FIG. 3B is a schematic diagram illustrating another data format of a trip video frame data having trip message according to an embodiment of the present invention. Referring to FIG. 3B, in the trip video frame data of FIG. 3B, every 30 video frames corresponds to one trip data, i.e. the trip data GI0, GI30, GI60, . . . , GIn are sequentially embedded into the headers H30, H330, H360, . . . , H3n or the redundancy bits of the video frames 30, 330, 360, . . . , 3n.

Besides, the trip video frame data also simultaneously includes a voice streaming and the video streaming. Though according to the aforementioned data format, the trip message is included in the header or redundancy bit of the corresponding video frame, the data format is not used for limiting the present invention. According to another data format, the trip message can also be included in the voice streaming. The voice streaming has a plurality of voice signals corresponding to each of the video frames, and the trip video frame data further has the voice signals corresponding to the video frames. The trip message is included within the headers or the redundancy bits of the voice signals corresponding to the video frames. During decoding, as long as the trip message included within the voice streaming can be decoded, and the corresponding video frame can be found, when the trip video frame data is played, a user then obtain the corresponding trip message from each of the video frames.

In an application, a video standard applied to the video streaming can be a motion-JPEG standard, an ITU-T video standard, an MPEG-1 standard, an MPEG-2 standard, an MPEG-4 standard or an Xvid standard. Moreover, an audio standard applied to the audio streaming can be an MP3 audio standard, an AAC audio standard, a WMA audio standard, a WAV audio standard or an OGG audio standard. However, the aforementioned standards are not used for limiting the present invention.

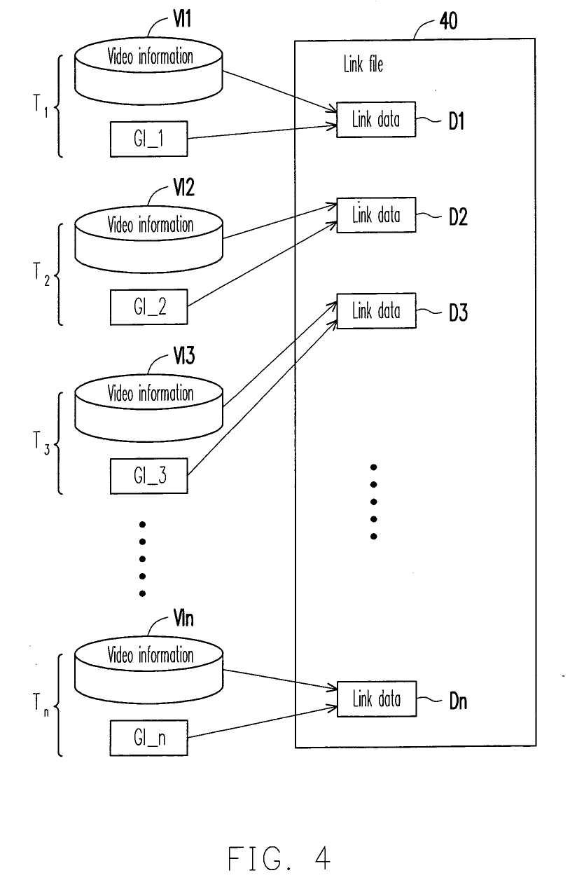

FIG. 4 is a schematic diagram illustrating another data format of a trip video frame data having trip message according to an embodiment of the present invention. Referring to FIG. 4, the trip video frame data is a link file 40 used for recording link relations between the trip message and the corresponding video frames. The link file 40 includes a plurality of link data D1˜Dn, wherein the link data D1˜Dn respectively record the link relations between video information VI1˜VIn and trip message GI_1˜GI_n.

When the video frames are played, a player reads the link file 40 and the corresponding video streaming, and performs decoding according to the link relations between the trip message and the video frames in the dynamic data streaming recorded in the link file 40. Then, the player simultaneously plays the video frames and the corresponding trip message according to decoding results.

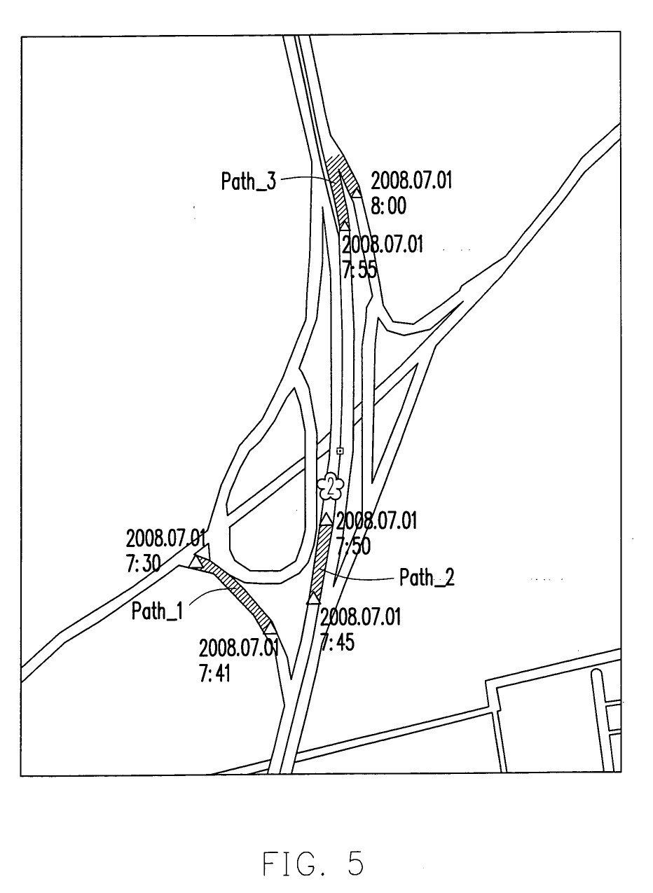

Next, referring to FIG. 5, FIG. 5 is a schematic diagram illustrating a map frame displayed based on a method for simultaneously playing video frames and trip message according to an embodiment of the present invention. When the trip video frame data having the trip message is decoded, the map frame of FIG. 5 displays at least one trip announcement of at least one trip message according to the plurality of trip message in the trip video frame data. In the present embodiment, the trip announcements are paths Path_1˜Patch_3 and time corresponding to starting points and ending points of each path. However, the trip announcements displayed at the starting point and the ending point of each of the paths can also be longitude and latitude, altitude, road name, speed, forward direction, engine rotating speed, fuel quantity and engine temperature, etc. of the trip message. In brief, types of the trip announcements displayed at the starting point and the ending point are not used for limiting the present invention. Moreover, in the present embodiment, though the map is applied for displaying the trip announcements, in another embodiment, the trip announcements can also be displayed by a chart.

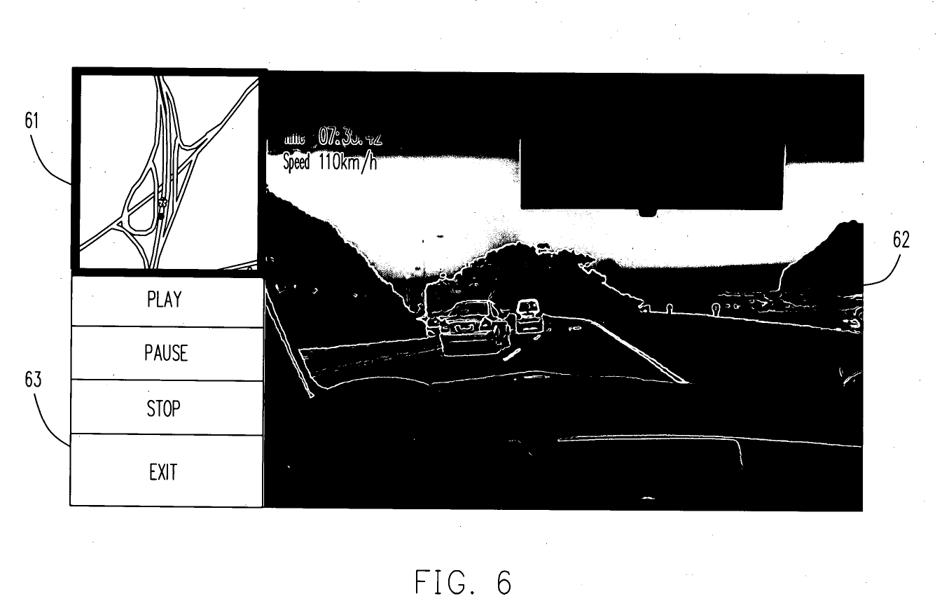

Next, corresponding video frames are selected from the three paths Path_1˜Path_3 for displaying according to a designated tag message. After the corresponding video frame is selected and displayed according to the designated tag message (for example, a video frame at the starting point of the path Path_2 is selected and displayed according to the designated tag message), the video frame is then displayed as that shown in FIG. 6. Wherein, the displayed frame includes a mini map frame 61, a video displaying frame 62 and a control frame 63. The control frame 63 further includes a plurality of functional blocks, and when the functional blocks are selected (for example, are touched), a corresponding function is then selected. In the present embodiment, the functional blocks include a play block, a pause block, a stop block and an exit block. However, these functional blocks are not used for limiting the present invention.

The mini map frame 61 displays a current position of the presently displayed video frame according to the trip message. The video displaying frame 62 displays the video frame selected based on the designated tag message, and also continually displays a plurality of video frames next to the selected video frame. In other words, the video displaying frame 62 sets the video frame selected based on the designated tag message as a starting play point, and continually plays the follow-up video frames from the starting play point.

In addition, in the present embodiment, the video displaying frame 62 further displays the corresponding trip message according to the designated tag message, so that the user can know the corresponding location of the video frame from the mini map frame 61 or can see the corresponding geographic information and cruise status information of the displayed video frame from the video displaying frame 62. In the present embodiment, the trip message displayed in the video displaying frame 62 is time and speed. However, as described above, the trip message can also be the longitude and latitude, the altitude, the road name, the speed, the forward direction, the engine rotating speed, the fuel quantity and the engine temperature, etc. Certainly, when the video frames are continually displayed, the video displaying frame 62 can also display the trip message corresponding to the currently displayed video frame.

Moreover, the user can set a starting play point and an ending play point on the mini map frame 61. For example, the user can click and select a certain point of the path being played on the mini map frame 61 to be the starting play point. In other words, the user can arbitrarily determine a playing interval of the path being played according to the designated tag message. The designated tag message can be generated only according to a designated trip message, and the designated trip message can be used for selecting the video frames to be displayed. Alternatively, the designated tag message can be generated according to a designated starting trip point information and a designated ending trip point information, wherein the designated starting trip point information is used for setting the starting play point, and the designated ending trip point information is used for setting the ending play point. The designated trip message, the designated starting trip point information and the designated ending trip point information include latitude and longitude, altitude, road name, time, speed, forward direction, engine rotating speed, fuel quantity and engine temperature, etc. When the user is about to check the video frames corresponding to a certain road section, the user inputs the designated trip message (a name of the road section) to display the video frames corresponding to the name of the road section. Certainly, when the user is about to check the video frames with the trip message of speed thereof exceeding a certain speed, the user only set the speed of the designated trip message to be more than a threshold value, and then the video frames with the trip message of speed thereof exceeding the certain speed can be viewed.

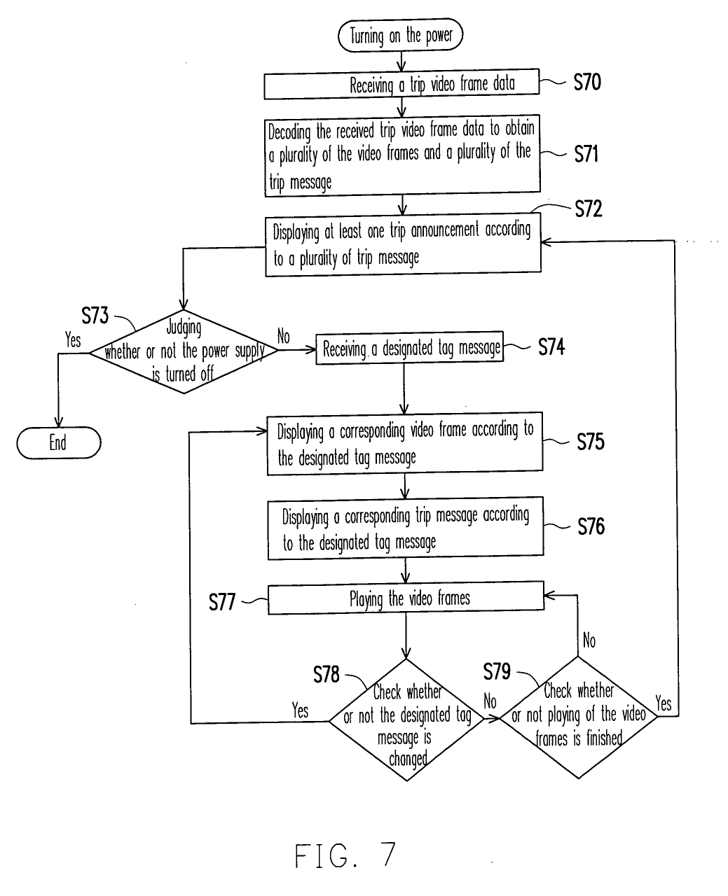

Next, referring to FIG. 7, FIG. 7 is a flowchart illustrating a method for simultaneously playing video frames and trip message according to an embodiment of the present invention. The method at least includes the following steps: (S70) receiving a trip video frame data; (S71) decoding the trip video frame data to obtain a plurality of video frames and a plurality of trip message, wherein each of the trip message corresponds to one of the video frames; (S77) simultaneously displaying at least one video frame and a trip message corresponding to the video frame.

In addition, other steps shown in FIG. 7 are optional steps. The method of FIG. 7 can be applied to a player device. In the following content, all steps shown in FIG. 7 are described. In the step S70, the trip video frame data is received, wherein the data format of the trip video frame data can be any data format as that described above. Next, in the step S71, the received trip video frame data is decoded to obtain a plurality of the video frames and a plurality of the trip message, wherein the decoding is performed based on the data format of the trip video frame data. For example, one of the aforementioned data formats is that the trip message is included in the headers of the corresponding video frames, the decoding method thereof is then to extract the trip message from the corresponding header, and output the video frame and the trip message.

Next, in step S72, at least one trip announcement is displayed according to a plurality of trip message. According to the step S72, the trip announcements can be displayed on a map or a chart, and the map can be as that shown in FIG. 5, though the present invention is not limited thereto. Next, in step S73, whether or not the power supply is turned off is checked. If yes, executions of the steps are ended; if not, step S74 is then executed. If the user does not want to see the video frames of multiple paths displayed on the map, the user can directly turn off the power supply of the player device. If the user wants to see the video frames of one of the multiple paths shown on the map, a designated tag message is then required to be input, and in the step S74, the player device receives the designated tag message.

Next, in step S75, a corresponding video frame is displayed according to the designated tag message. In step S76, a corresponding trip message is displayed according to the designated tag message. Moreover, as described above, the designated tag message can be used for setting the starting play point and the ending play point. Therefore, in the step S77, a plurality of video frames is continually played from the starting play point to the ending play point. While the video frames are displayed, the trip message corresponding to the video frames are also displayed. The frames displayed based on the steps S75, S76 and S77 can be as that shown in FIG. 6, though the present invention is not limited thereto.

Next, in step S78, whether or not the designated tag message is changed (for example, changing of time, road name or latitude and longitude, etc. of the designated tag message) is checked. If not, step S79 is then executed; if yes, the step S75 is then re-executed. In the step S79, whether or not playing of the video frames is finished is checked, i.e. whether or not the video frames are played to the ending play point is checked. If yes, the step S72 is then re-executed; if not, the step S77 is then re-executed for continually playing the video frames to the ending play point.

Generally, the user sometimes want to view the video frames corresponding to a certain position or a certain coordinates of the selected path, in this case, the user can reset the current starting play point by changing the designated tag message. For example, the user can select a certain position of the current path from the mini map frame 61 of FIG. 6 for viewing the corresponding video frames. Moreover, if playing of the video frames is finished, the step S72 is re-executed, so that the corresponding video frames can be displayed according to the designated tag message.

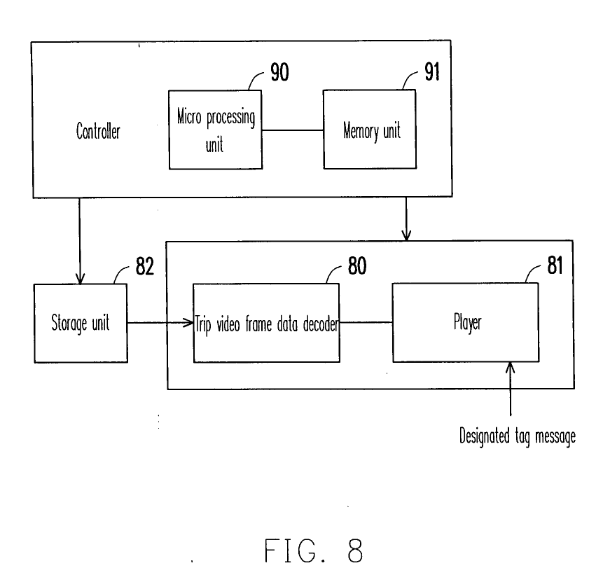

Finally, referring to FIG. 8, FIG. 8 is a system block diagram illustrating an apparatus and a controller thereof for simultaneously playing video frames and trip message according to an embodiment of the present invention.

The controller includes a micro processing unit 90 and a memory unit 91. The memory unit 91 is coupled to the micro processing unit 90, and the micro processing unit 90 is used for controlling the other units connected to the controller. The memory unit 91 stores a program code therein, and when the program code is executed, the micro processing unit 90 controls the other units connected to the controller to perform the following steps: (a) receiving a trip video frame data; (b) decoding the trip video frame data to obtain a plurality of video frames and a plurality of trip message, wherein each of the trip message corresponds to one of the video frames; (c) simultaneously displaying at least one video frame and a trip message corresponding to the video frame.

Moreover, the apparatus for simultaneously playing video frames and trip message includes a trip video frame data decoder 80 and a player 81, wherein the trip video frame data decoder 80 is coupled to the player 81.

The trip video frame data decoder 80 is used for receiving the trip video frame data from a storage unit 82, and decoding the trip video frame data to obtain a plurality of the video frames and a plurality of the trip message, wherein each of the trip message corresponds to one of the video frames. The player 81 is used for displaying trip announcements of the trip message on the map according to the plurality of trip message, and receiving the designated tag message for displaying the corresponding video frames according to the received designated tag message (as shown in FIG. 5 and FIG. 6).

Moreover, the player 81 further continually displays the plurality of corresponding video frames according to the designated tag message, wherein the designated tag message includes the corresponding starting play point and the ending play point of the corresponding video frames.

In summary, the present invention provides a method and an apparatus for simultaneously playing video frames and trip message. Therefore, when the trip video frames data are played based on the above method and apparatus, the corresponding video frames can be searched according to the trip message or time, so that the user conveniently searches the video frames. Moreover, during the playing, the user can simultaneously see the video frames and the corresponding trip message, so that a better monitoring effect is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for simultaneously playing video frames and trip message, comprising:
receiving a trip video frame data;
decoding the trip video frame data to obtain a plurality of video frames and a plurality of trip message, wherein each of the trip message corresponds to one of the video frames; and
simultaneously displaying at least one video frame and a trip message corresponding to the video frame.

2. The method for simultaneously playing video frames and trip message as claimed in claim 1 further comprising:
displaying at least one trip announcement according to the plurality of trip message;
receiving a designated tag message; and
displaying the corresponding video frame and the trip message according to the designated tag message.

3. The method for simultaneously playing video frames and trip message as claimed in claim 1, wherein the trip announcement is marked on a map.

4. The method for simultaneously playing video frames and trip message as claimed in claim 1, wherein the trip announcement is displayed by a chart.

5. The method for simultaneously playing video frames and trip message as claimed in claim 2 further comprising:
simultaneously displaying the video frames and the corresponding trip message according to the designated tag message, continually.

6. The method for simultaneously playing video frames and trip message as claimed in claim 1 further comprising:
simultaneously displaying the video frames next to a first video frame and the corresponding trip message thereof, continually.

7. The method for simultaneously playing video frames and trip message as claimed in claim 1, wherein the designated tag message comprises a starting play point and an ending play point of the corresponding video frames, and the starting play point and the ending play point of the video frames are respectively generated according to a designated starting trip point information and a designated ending trip point information.

8. The method for simultaneously playing video frames and trip message as claimed in claim 2 further comprising:
displaying the corresponding trip message according to the designated tag message.

9. The method for simultaneously playing video frames and trip message as claimed in claim 1, wherein each of the trip message comprises a longitude and latitude, an altitude, a road name, a time, a speed, a forward direction, an engine rotating speed, a fuel quantity or an engine temperature.

10. The method for simultaneously playing video frames and trip message as claimed in claim 3, wherein the video frame and the map is displayed in the same frame.

11. The method for simultaneously playing video frames and trip message as claimed in claim 2, wherein the designated tag message is generated according to a designated trip message comprising a longitude and latitude, an altitude, a road name, a time, a speed, a forward direction, an engine rotating speed, a fuel quantity or an engine temperature.

12. The method for simultaneously playing video frames and trip message as claimed in claim 7, wherein the designated starting trip point information and the designated ending trip point information comprise a longitude and latitude, an altitude, a road name, a time, a speed, a forward direction, an engine rotating speed, a fuel quantity or an engine temperature.

13. An apparatus for simultaneously playing video frames and trip message, comprising:
a trip video frame data decoder, for receiving a trip video frame data, and decoding the trip video frame data to obtain a plurality of video frames and a plurality of trip message, wherein each of the trip message corresponds to one of the video frames; and
a player, coupled to the trip video frame data decoder, for simultaneously displaying at least one video frame and a trip message corresponding to the video frame.

14. The apparatus as claimed in claim 13, wherein the player further displays at least one trip announcement according to the plurality of trip message, and is used for receiving a designated tag message, and displaying the corresponding video frame and the trip message according to the designated tag message.

15. The apparatus as claimed in claim 14, wherein the trip announcement is marked on a map.

16. The apparatus as claimed in claim 14, wherein the trip announcement is displayed by a chart.

17. The apparatus as claimed in claim 14, wherein the player further continually displays the video frames and the corresponding trip message from a first video frame thereof according to the designated tag message.

18. The apparatus as claimed in claim 13, wherein the player simultaneously displays the video frames next to the first video frame and the corresponding trip message thereof, continually.

19. The apparatus as claimed in claim 14, wherein the designated tag message comprises a starting play point and an ending play point of the corresponding video frames, and the starting play point and the ending play point of the video frames are respectively generated according to a designated starting trip point information and a designated ending trip point information.

20. The apparatus as claimed in claim 14, wherein the player further plays the corresponding trip message according to the designated tag message.

21. The apparatus as claimed in claim 13, wherein each of the trip message comprises a longitude and latitude, an altitude, a road name, a time, a speed, a forward direction, an engine rotating speed, a fuel quantity or an engine temperature.

22. The apparatus as claimed in claim 15, wherein the video frame and the map are displayed in the same frame.

23. The apparatus as claimed in claim 14, wherein the designated tag message is generated according to a designated trip message comprising a longitude and latitude, an altitude, a road name, a time, a speed, a forward direction, an engine rotating speed, a fuel quantity or an engine temperature.

24. The apparatus as claimed in claim 19, wherein the designated starting trip point information and the designated ending trip point information comprise a longitude and latitude, an altitude, a road name, a time, a speed, a forward direction, an engine rotating speed, a fuel quantity or an engine temperature.

25. A controller, for simultaneously playing video frames and trip message, the controller comprising:
a micro processing unit, for controlling other units connected to the controller; and
a memory unit, coupled to the micro processing unit, and the memory unit having a program code, wherein when the program code is executed, the micro processing unit controls the other units connected to the controller to execute the following steps:
receiving a trip video frame data;
decoding the trip video frame data to obtain a plurality of video frames and a plurality of trip message, wherein each of the trip message corresponds to one of the video frames; and
simultaneously displaying at least one video frame and a trip message corresponding to the video frame.

26. The controller as claimed in claim 25, wherein the micro processing unit further controls the other units connected to the controller to perform the following steps:
displaying at least one trip announcement according to the plurality of trip message;
receiving a designated tag message; and
displaying the corresponding video frame and the trip message according to the designated tag message.

27. The controller as claimed in claim 26, wherein the trip announcement is marked on a map.

28. The controller as claimed in claim 26, wherein the trip announcement is displayed by a chart.

29. The controller as claimed in claim 26, wherein the micro processing unit further controls the other units connected to the controller to perform the following steps:
simultaneously displaying the video frames and the corresponding trip message according to the designated tag message, continually.

30. The controller as claimed in claim 25, wherein the micro processing unit further controls the other units connected to the controller to perform the following steps:
simultaneously displaying the video frames next to a first video frame and the corresponding trip message thereof, continually.

31. The controller as claimed in claim 26, wherein the designated tag message comprises a starting play point and an ending play point of the corresponding video frames, and the starting play point and the ending play point of the video frames are respectively generated according to a designated starting trip point information and a designated ending trip point information.

32. The controller as claimed in claim 26, wherein the micro processing unit further controls the other units connected to the controller to perform the following steps:
displaying the corresponding trip message according to the designated tag message.

33. The controller as claimed in claim 25, wherein each of the trip message comprises a longitude and latitude, an altitude, a road name, a time, a speed, a forward direction, an engine rotating speed, a fuel quantity or an engine temperature.

34. The controller as claimed in claim 27, wherein the video frame and the map, are displayed in a same frame.

35. The controller as claimed in claim 26, wherein the designated tag message is generated according to a designated trip message comprising a longitude and latitude, an altitude, a road name, a time, a speed, a forward direction, an engine rotating speed, a fuel quantity or an engine temperature.

36. The controller as claimed in claim 31, wherein the designated starting trip point information and the designated ending trip point information comprise a longitude and latitude, an altitude, a road name, a time, a speed, a forward direction, an engine rotating speed, a fuel quantity or an engine temperature.
